(19) United States
(12) Patent Application Publication
(10) Pub. No.: US 2009/0242067 A1
(43) Pub. Date: Oct. 1, 2009

(54) PROCESSES FOR TEXTURED PIPE MANUFACTURER

(76) Inventor: Rachata Leelaprachakul, Bangkok (TH)

Correspondence Address: Pearne & Gordon LLP, 1801 East 9th Street, Suite 1200, Cleveland, OH, 44114-3108, US

(21) Appl. No.: 12/170,881

(22) Filed: Jul. 10, 2008

(30) Foreign Application Priority Data
Mar. 27, 2008 (TH) 0801001555

(51) Int. Cl. F16L 9/00; C22C 38/00

(52) U.S. Cl. 138/177; 138/DIG. 11; 420/8

(57) ABSTRACT

The present invention relates to processes for textured pipe manufacturer on the outside and/or the inside surfaces for industrial application and aesthetic.

### FIELD OF THE INVENTION

The present invention relates to processes for textured pipe manufacturer. More specifically, the present invention relates to the processes for manufacturing textured pipe having aesthetic surface.

### TECHNICAL FIELD

Mechanical engineering, industrial engineering.

### BACKGROUND OF THE INVENTION

Usually, any pipes fabricated from iron, aluminium, titanium, copper, stainless steel or alloy steels with carbon, nickel, chromium, manganese, molybdenum used for general engineering applications, have smooth surfaces for the purposes of the ease in cleaning and low fabricating cost. In some industrial applications, however, pipes having textures either on one surface or both surfaces (inside and outside) are required for each particular application such as aesthetic and heat transfer. The texture on the pipe surface will increase the heat transfer rate according to the formula

$$Q = \frac{KA ( {T}_{i} - {T}_{0} )}{X}$$

where Q—amount of heat transfer

K—heat transfer coefficient

A—heat transfer area

T—temperature at the surface of the media

X—thickness of the media

The equation above shows that the amount of heat transfer proportional varies with the area of the media and inversely varies with the thickness of the media. On the other hand, the more the area of the media, the more the amount of heat can be transferred. On the contrary, the more the thickness of the media, the less the amount of heat can be transferred. Embossing on the surface of a metal sheet will increase the surface area of the metal sheet and change the thickness of the metal which results in increasing the efficiency of the heat transfer rate (FIGS. 1 and 2). In FIG. 2, 2 and 4 are the increased surface area of the pipe. The amount of this increase depends on the depth of the embossing (A increases). In addition, the thickness of the areas 1 and 3 also decrease (X decrease).

### DESCRIPTION OF THE DRAWINGS

FIG. 1 shows an example of texture on the surface pipe.

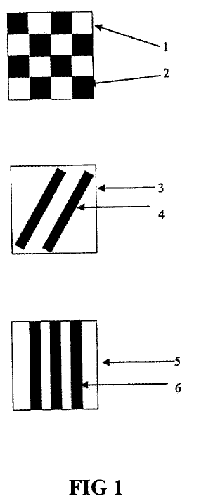

FIG. 2 shows the cross sectional area of the texture in FIG. 1.

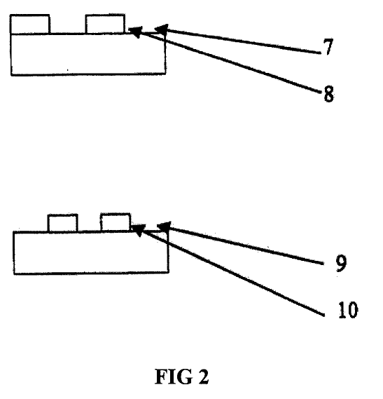

FIG. 3 shows an example of embossing machine.

FIG. 4 shows a pipe fabricating machine.

### DETAILS OF THE INVENTION

Metals used in the manufacturing of pipe usually is in the form of a sheet with a uniform thickness. The metals may be iron, aluminium, titanium, copper and alloys which comprise of iron, carbon, nickel, manganese, chromium such as stainless steel. This metal can be fabricated to form pipes having different diameters suitable for each industrial application. For example, they may be used as heat removal/carrier pipe for unit operations or transfer fluids. These metals are a good heat conductor and some kinds can withstand chemical attack or used as furniture for building. Embossing on each metal surface typically uses a mold having higher hardness than the hardness of the metal to be embossed. Molds made from different material will have different durability.

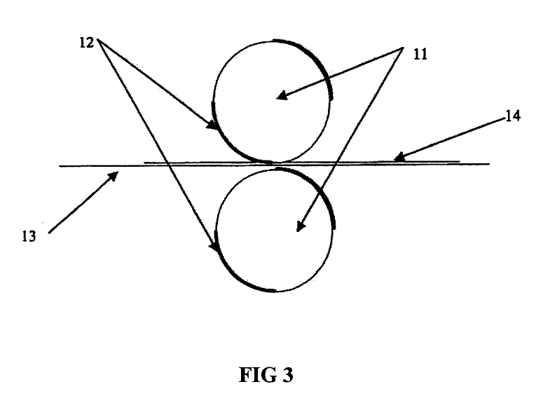

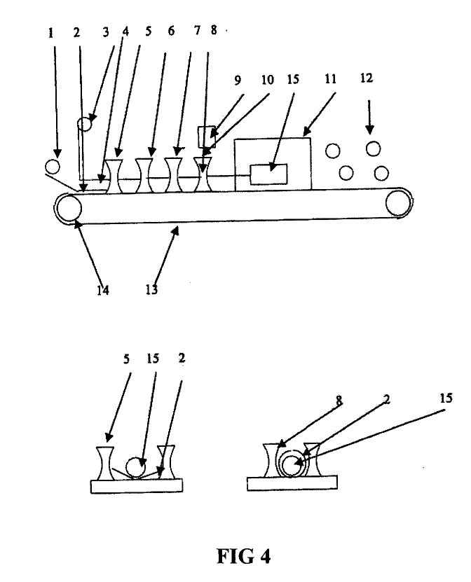

During the manufacturing process, the metal sheet is cut to fit the size of the emboss machine. The emboss machine (FIG. 3) comprises of rollers 11, which have mold(s) 12, installed on the moving path 13 of the metal sheet. When the metal sheet 14 is drawn through the path between the two rollers 11, its surface(s) will be embossed via the press of the mold(s) onto its surface(s). The depth of the texture embossed depends on the depth of the mold. After being embossed, the metal sheet is smoothed and cut to the size of the pipe to be manufactured. In FIG. 4, the metal sheet (1) is unwound (2) and inserted to the rail of the machine (13) to fold the metal sheet into pipe. The rail (13), driven by a driver (14), guides the metal sheet to the pressing process which uses a series of rollers (5, 6, 7 and 8) installed along the moving path way of the metal sheet. A support roller (15) with an appropriate length acting as a support for pressing the seam has a solid cylindrical shape. The diameter of the support roller equals to the inside diameter of the pipe to be manufactured. The support roller (15) is tied with a wire (4) wound on a roller (3). The wire (4) will pull the supper roller (15) to move back when it finishes its task. When the metal band (2) is inserted into the space between the rollers, the rollers (5, 6, 7 and 8), which roll around vertical axes, the metal band will be gradually folded from the horizontal line to the circumference of the rollers until its edges meet squarely and become welded. The edges are welded by a welding machine (9) and electrodes (10). The welding process may or may not use welding rod. The heat will melt the edges (and welding rod, if used) to become a homogeneous seam. After the welding process, the pipe is drawn to a tunnel (11) to anneal the seam. Then the annealed pipe is straightened by rollers (12). The described pipe manufacturing process can be used with any textured metal sheet having texture on the outside and/or the inside surfaces.

1. Textured pipe having texture on its surface(s) manufactured by:
emboss a metal sheet to have a desired texture;
cut the metal sheet to a desired dimension;
fold the metal sheet into a pipe;
weld the edges of the metal sheet to obtain a pipe; and
straighten the obtained pipe to become textured pipe having texture on its outside and/or inside surfaces.

2. The textured pipe according to claim 1 which is made from aluminium or aluminium alloys.

3. The textured pipe according to claim 1 which is made from copper.

4. The textured pipe according to claim 1 which is made from titanium or titanium alloy.

5. The textured pipe according to claim 1 which is made from iron alloyed with at least one element selected from the group of nickel, chromium, manganese, carbon, aluminium, and molybdenum or the mixture of the said elements.
